(19) United States
(12) Patent Application Publication
(10) Pub. No.: US 2011/0141144 A1
(43) Pub. Date: Jun. 16, 2011

(54) CONTENT DISPLAY MAGNIFICATION CHANGING METHOD AND CONTENT DISPLAY MAGNIFICATION CHANGING PROGRAM

(75) Inventor: Masayuki Tomono, Chiba (JP)

(73) Assignee: ACCESS CO., LTD., Tokyo (JP)

(21) Appl. No.: 13/058,524

(22) PCT Filed: Aug. 7, 2009
(86) PCT No.: PCT/JP2009/063997

§ 371 Date: Feb. 10, 2011

(30) Foreign Application Priority Data
Aug. 13, 2008 (JP) 2008208751

(51) Int. Cl. G09G 5/00

(52) U.S. Cl. 345/660

(57) ABSTRACT

Disclosed is a content display magnification changing method which executes an indicator setting step wherein a prescribed indicator is set when content is displayed on a display screen, an indicator size changing step wherein the display size of said indicator is changed according to the amount of dragging operation when a dragging operation with respect to the indicator that has been set is received, and a content display magnification changing step wherein the display magnification of the content is changed in response to the change in the display size of the indicator.

### TECHNICAL FIELD

The present invention relates to a method and a program for changing a display magnification of contents displayed on a screen, and particularly to a method and a program capable of easily changing the display magnification to a desired display magnification through a user's intuitive operation.

### BACKGROUND OF THE INVENTION

Content browsing applications, such as a viewer for browsing an electronic file (e.g., an image or a document) and a Web browser for browsing Web contents, have been known and in practical use. In general, a content browsing application is provided with a display magnification changing function for changing the display magnification of contents so as to display details of contents or to display, on one screen, the whole contents having the size larger than a screen size.

U.S. Patent Application Publication No. 2008/0036793 (hereafter, referred to as patent document 1) discloses an example of a device on which an application having the display magnification changing function is installed. Patent document 1 discloses a display magnification changing technology which, when a certain position on a screen is touched by a user's finger during displaying of contents, keeps displaying, at the touched position, an image which was located at the touched position on the screen, and continuously displays the whole image in an enlarged state or in a reduced state until the user's finger is detached from the screen. According to the patent document 1, it is possible to change the display magnification of contents by merely touching continuously the screen by a finger. In addition to the operation described in patent document 1, a touching operation conducted by inputting a plurality of points (e.g., a pinching operation on a touch panel capable of detecting a plurality of points) is also known, as a display magnification changing operation for contents by a touching operation. The pinching operation means an operation in which, by broadening or narrowing the distance between two fingers in a state where the two fingers are touching a touch panel, the contents being displayed are enlarged or reduced.

As a display magnification changing operation by an operation other than a touching operation (e.g., a mouse, ten-key, or directional key operation), an operation for selecting a display magnification from options on a tool bar (e.g., a pull-down menu) installed on a content browsing application or an operation with respect an indicator (e.g., a zoom bar) for changing the display magnification is known.

### DISCLOSURE OF THE INVENTION

However, with regard to the display magnification changing operation described in patent document 1, there is an inconvenience that it is difficult for a user to sensuously grasp the relationship between the time length of finger-touching and the changed magnification by repetitively conducting the display magnification changing operation, and therefore it is impossible to smoothly conduct the display magnification changing operation. With regard to the display magnification changing operation by the pinching operation, there is also an inconvenience that it is difficult for a user to sensuously grasp the relationship between the finger's movement (the amount of movement, the speed and the direction of the finger) during the pinching operation and the changed display magnification, and therefore it is impossible to smoothly conduct the display magnification changing operation. Furthermore, with regard to the pinching operation, there are concerns that the visual range of the user might be blocked by the user's finger. Furthermore, the pinching operation is difficult to conduct because the pinching operation requires the user to use a plurality of fingers simultaneously. That is, it is difficult to sensuously change the display magnification of contents by the operation described in patent document 1 or the pinching operation.

Furthermore, with regard to the display magnification changing operation other than the touching operation, e.g., an operation for changing the display magnification by selecting options on a tool-bar, there is an inconvenience that it is difficult for a user to sensuously grasp the relationship between the display magnifications of contents before and after the display magnification changing operation (e.g., how the display magnification has changed with respect to the state before the display magnification changing operation). In the case where the display magnification is changed by operating a zoom bar, there is also an inconvenience that it is difficult to sensuously grasp the relationship between the amount of operation with respect to the zoom bar and the changed magnification.

In view of the above described circumstances, the object of the present invention is to provide a content display magnification changing method and a content display magnification changing program capable of easily changing the display magnification of contents to a desired magnification by a user's sensuous operation.

To solve the above described problem, according to an embodiment, a method suitable for changing the display magnification of contents to a desired magnification through an intuitive user operation is provided. Specifically, the method includes an indicator setting step of setting a predetermined indicator, an indicator size changing step of changing a display size of the indicator in response to a amount of dragging operation when a dragging operation with respect to the set indicator is accepted, and a content display magnification changing step of changing a display magnification of the contents in accordance with change of the display size of the indicator.

According to the above described content display magnification changing method, since the display magnification of the contents is changed in accordance with change of the display size of the indicator corresponding to the amount of dragging operation, a user is able to easily recognize visually change of the display magnification of the contents. Furthermore, since the display magnification of the contents is changed by a simple operation such as a dragging operation, the user is not required to have a lot of skill. For example, it is possible to provide a operational environment where the user is able to change easily the display magnification with one finger, in contrast to a pinching operation. It is also possible to provide an operation environment where the user's visual range for the contents is not blocked.

In order to enable the user to more easily recognize visually the change of the display magnification of the contents, it is preferable that, in the content display magnification changing step, the display magnification is changed by applying a change rate of the display size of the indicator to the display magnification of the contents such that a rate between the display size of the indicator and a display size of the contents is kept constant.

It is preferable that, in the content display magnification changing step, the display magnification of the contents is changed in a state where a center of a display position of the indicator (e.g., a place which a user wants to carefully watch) on the display screen is fixed, for example, when the contents are enlarged and displayed.

In the indicator setting step, a predetermined indicator image may be displayed at a position on the display screen designated by a user operation. It is preferable that the predetermined indicator image is a ring-shaped mark having a center equal to a position of the display screen designated by the user operation. Use of such a ring-shaped mark is preferable, because the ring-shaped mark does not block display an area on the display screen which is designated by the user and which lies inside the ring-shaped mark.

In the indicator size changing step, when a dragging operation is conducted with respect to the ring-shaped mark, a display size of the ring-shaped mark is changed in response to an amount of the dragging operation. Therefore, the area on the display screen designated by the user operation is not blocked by a pointer or a user's finger for the dragging operation. In the indicator size changing step, the amount of the dragging operation is determined based on a difference between a distance between the center of the ring-shaped mark and a designation start point of the user operation and a distance between the center of the ring-shaped mark and a designation end point of the user operation. In such a indicator size changing step, the display size of the ring-shaped mark may be changed in additionally considering the direction of the dragging operation as well as the amount of dragging operation. It is preferable that, in the indicator size changing step, when the designation end point is moved from the designation start point of the user operation to approach the center of the ring-shaped mark, the indicator is reduced and displayed in accordance with the difference; and when the designation end point is moved from the designation start point to be away from the center of the ring-shaped mark, the indicator is enlarged and displayed in accordance with the difference.

The content display magnification changing method may further include a ring-shaped mark erasing step of erasing the ring-shaped mark when an area on the contents other than the ring-shaped mark is designated.

In the indicator setting step, an element of the contents designated by a user operation may be set as the predetermined indicator. In this case, it is not necessary to install a dedicated mark such as the above described ring-shaped mark. In the indicator setting step, in order to clearly provide an indicator for the user, it is preferable that the element designated as the indicator is highlighted. In the indicator setting step, the element designated as the indicator may be displayed at a center of the display screen.

In order to prevent an unintended process of the user from being executed, it is preferable that the content display magnification changing method executes a dynamic element stopping step of stopping or invalidating a dynamic element of elements of the contents.

The content display magnification changing method according to the invention may further include: an icon display step of displaying a predetermined icon supporting change of the display magnification of the contents; and a prescribed magnification setting step of setting the display magnification of the contents to a prescribed magnification when the icon is designated.

The content display magnification changing method according to the invention may further include a content display area change step of, when a dragging operation is conducted with respect to an area on the contents other than the indicator, scrolling or sliding a display area of the contents in response to the dragging operation in a state where a display position of the indicator is fixed.

A content display magnification changing program according to an embodiment of the invention is a program causing a computer to execute the steps of any of the above described content display magnification changing method.

According to the invention, the content display magnification changing method and the content display magnification changing program capable of easily changing the display magnification of the contents to a desired magnification by a user's intuitive operation can be provided.

### BRIEF DESCRIPTION OF THE DRAWINGS

FIG. 1 illustrates an outer appearance of a terminal device according to an embodiment of the present invention.

FIG. 2 is a block diagram illustrating a general configuration of the terminal device according to the embodiment of the invention.

FIG. 3 is a functional block diagram of a browser engine included in a browser according to the embodiment of the invention.

FIG. 4 illustrates the entire Web contents for explaining the embodiment of the invention.

FIG. 5 is an example of display of the Web contents displayed on the browser according to the embodiment of the invention.

FIG. 6 is a flowchart illustrating a display magnification changing process executed by the browser according to the embodiment of the invention.

FIG. 7 is an example of display of the Web contents displayed on the browser according to the embodiment of the invention.

FIG. 8 illustrates a relationship between the entire Web contents before a zoom ring is dragged and an area displayed on a screen.

FIG. 9 illustrates a relationship between the entire Web contents after the zoom ring is dragged and an area displayed on the screen.

FIG. 10 is a flowchart illustrating a display magnification changing process executed by a browser according to another embodiment.

FIG. 11 illustrates an example of display of the Web contents displayed on a browser according to another embodiment.

FIG. 12 illustrates an example of display of the Web contents displayed on a browser according to another embodiment.

### BEST MODE FOR CARRYING OUT THE INVENTION

Hereafter, an embodiment according to the invention is described with reference to the accompanying drawings.

First, terms used herein are defined as follows.
Network: Various types of networks including a mobile communication network of a mobile communication carrier, an intranet and the Internet.
Contents: a group of information including video, an image, sound, a document, data such as a work sheet or a combination thereof to be browsed by a user. Contents are transmitted through a network or is stored in a terminal device.
Web contents: a form of contents. The Web contents are a group of information transmitted through a network.
Web page: a form of Web contents. The Web page represents an entire content to be displayed when a user designates an URL. That is, the Web page represents an entire content which can be displayed by scrolling onscreen representation on a display. The Web page includes not only a Web page being browsed online but also a Web page being browsed offline. The Web page being browsed offline includes, for example, a page which is cached by a browser after having been received from the Internet, or a page stored, for example, in a local folder of a terminal device in an mht format. The Web page includes various types of information (Web page data), such as, an HTML (Hyper Text Markup Language) document, an XHTML (Extensible Hyper Text Markup Language) document, an image file, sound data and etc.

According to the above described definitions, contents include Web contents, and Web contents include a Web page.

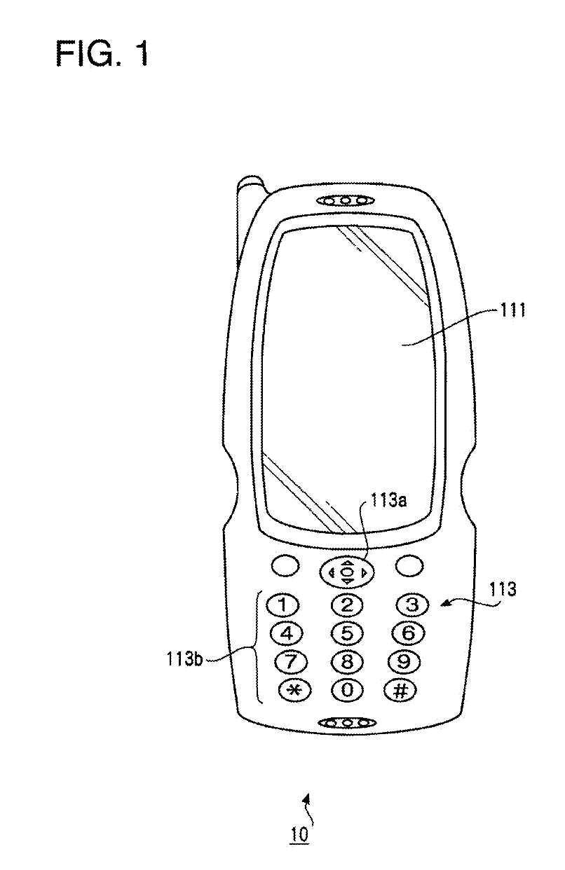

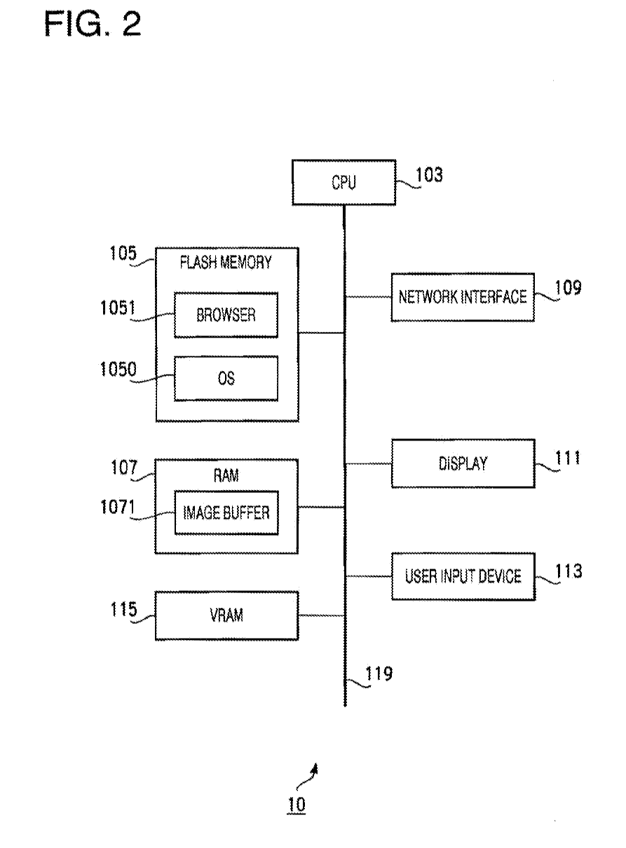

FIG. 1 illustrates an outer appearance of a terminal device 10 according to the embodiment of the invention. FIG. 2 is a block diagram generally illustrating a configuration of the terminal device 10. Although in this embodiment the terminal device 10 is a mobile phone, the terminal device 10 may be replace with another type of device, such as a PDA (Personal Digital Assistant), a PHS (Personal Handy phone System), a portable game machine, a home appliance, a desktop PC, and a laptop PC on which a Web browser is installed.

As shown in FIG. 2, the terminal device 10 includes a CPU (Central Processing Unit) 103 which totally controls the entire device. Each component configuring the terminal device 10 is connected to the CPU 103 via a system bus 119. As components configuring the terminal device 10, the terminal device 10 includes a flash memory 105, a RAM (Random Access Memory) 107, a network interface 109, a display 111, a user input device 113 and a VRAM (Video Random Access Memory) 115. The system bus 119 includes a power line in addition to a data line. To the components of the terminal device 10 including the CPU 103, power is supplied via the power line from a battery which is not shown in the drawings.

After the terminal device 10 is turned ON, the CPU 103 accesses necessary hardware components via the system bus 119. For example, immediately after the terminal device 10 is turned ON, the CPU 103 accesses the flash memory 105 to read an OS (Operating System) 1050, and loads the OS 1050 onto the RAM 107 to invoke the OS 1050. Then, the components execute various types of processing by coordinating with each other as appropriate under control of the OS 1050 managing resources and processes.

For example, when an operation for invoking a browser 1051 is conducted through the user input device 113, the OS 1050 loads the browser 1051 onto the RAM 107 to execute the browser 1051 on the OS 1050. The browser 1051 invoked by the OS 1050 executes a process in cooperation with hardware, such as the CPU 103, in response to, for example, a user operation for accessing Web contents. As a result of such a process, the user is able to execute Web browsing through the display 111, i.e., to browse Web contents.

As the user input device 113, the terminal device 10 is provided with a five-way key 113a and a ten-key 113b. The five-way key 113a is an integrated key including four (up, down, left and right) direction keys and an enter key. When a user operation for operating the user input device 113 is conducted, an input signal corresponding to the user operation is inputted to the CPU 103. Then, the CPU 103 executes a process corresponding to the user operation so that various functions including the Web browsing can be performed on the terminal device 10. During the Web browsing, the user is able to scroll the Web contents being browsed, by operating any of the five-way key 113a and the ten-key 113b. Furthermore, the user is able to select a form or a link on the contents by operating the five-way key 113a or the ten-key 113b.

It should be noted that the user input device 113 is not limited to a mechanical key, such as the five-way key 113a and the ten-key 113b. The user input device 113 may be configured by another type of key, such as a membrane key or a touch panel.

If the user input device 113 is configured with a touch panel, an operation screen corresponding to operation keys is configured by a display screen which is integrated with the display 111 or is provided separately from the display 111. In the former case, the display 111 itself is configured with a touch panel. In the latter case, the terminal device 10 includes two screens, i.e., the display 111 and an operation touch panel. Furthermore, in the latter case, whether to configure the display 111 with a touch panel is determined in accordance with design specifications.

As described above, if the user input device 113 is configured with a touch panel, a GUI (Graphical User Interface) environment in which an operation, such as scrolling and link selection, is conducted by pen-touch or finger-touch with respect to an operation key arranged on the screen is provided. It is also possible to provide a GUI environment where various operations are conducted, for example, by directly touching a screen on which Web contents are displayed. Under such a GUI environment, when the user moves the user's finger on a touch panel surface in the upward, downward, left or right direction from a state where the user's finger touches the touch panel surface at a certain point on the Web contents, scrolling is executed accordingly (e.g., by moving upward the user's finger on the touch panel surface, the Web contents are scrolled downward). That is, in this case, since scrolling is executed in response to movement of a stylus or a finger, more intuitive operability can be provided for the user.

The user input device 113 may be configured by appropriately combining various types of keys, such as a mechanical key, a membrane key and a touch panel. The user input device 113 may be a controller provided separately from the terminal device 10.

Furthermore, a component other than a mechanical key, a membrane key and a touch panel may be provided as a part of the user input device 113. As examples of such a component, a gyro-sensor, an acceleration sensor and a jerk sensor are named. In this case, the CPU 103 measures, for example, a tilting angle, an angular velocity, an acceleration and a jerk (a time-rate-of-change of an acceleration), so that scrolling responsive to measured values can be achieved by coordination between the CPU 103 and the browser 1051. For example, when the user moves or tilts the terminal device 10 in the upward, downward, left or right direction, scrolling responsive to the moving direction, moving speed or the tilting angle, etc. is executed. Such a configuration enables the user to intuitively scroll a display area of the Web contents.

The terminal device 10 according to the embodiment is designed to have a screen aspect ratio of, for example, 3:4 (i.e., portrait representation) in a normal use state (i.e., in a state where the terminal device 10 is oriented such that the up-and-down direction in FIG. 1 coincides with the vertical direction). When the posture of the terminal device 10 is changed from the above described state, the CPU 103 detects change of the posture of the terminal device 10 based on outputs from the sensors such as a gyro sensor. For the Web contents being displayed on the display 111, the browser 1051 executes rendering responsive to the posture of the terminal device 10 based on detection results by the CPU 103. For example, when the terminal device 10 is rotated by 90 degrees from the posture shown in FIG. 1, the screen aspect ratio is changed to 4:3 (i.e., landscape representation). At this time, the browser 1051 executes again rendering for the Web contents being displayed on the display 111 in accordance with the landscape screen. As described above, if the orientation of the screen is changed, line-wrapping positions of text by the rendering are also changed, and, as a result, appearance of the Web page changes.

As shown in FIG. 1, the terminal device 10 according to the embodiment is configured as a so-called straight type mobile phone which holds the display 111 and the user input device 113 with an integrated body. However, the terminal device 10 may employ a folding type, a rotational biaxial hinge type, a cycloid type or a swing type structure. For example, a mobile phone of a cycloid type or a swing type is configured such that a display side body holding the display 111 is rotatable, in a plane parallel with the display 111, relative to a main body holding the user input device 113. In such a mobile phone, the orientation of the screen changes in response to the rotational angle of the display side body. In this case, the browser 1051 executes again rendering for the Web contents being displayed on the display 111 in accordance with the changed orientation of the screen.

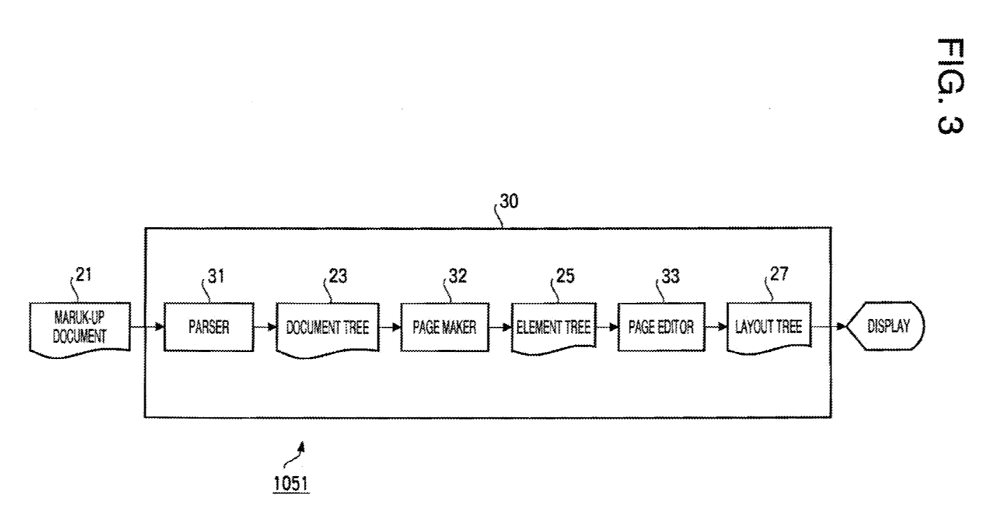

Next, functions of the browser 1051, particularly a browser engine 30 which is a primary component of the browser 1051, are explained in detail. FIG. 3 illustrates a functional block diagram of the browser engine 30. As shown in FIG. 3, the browser engine 30 includes various functional blocks including a parser 31, a page maker 32 and a page editor 33.

When an accessing operation to Web contents, e.g. input of a URI through the user input device 113 (or a URI is designated by selection of an anchor element on the Web contents, or a URI stored as a bookmark or history in the terminal device 10 is selected), is conducted, the browser 1051 generates a request message requesting for resources such as Web contents in compliance with HTTP (Hypertext Transfer Protocol), and transmits the request message to a designated URI.

Then, a server corresponding to the designated URI generates a response message corresponding to the received request message and replies. The replied response message reaches to the browser 1051 through the network and the response message is passed to the parser 31. In a message body of the response message, a markup document 21 designated by the URI, which is described in HTML or XHTML, etc., is embedded.

The parser 31 analyzes the markup document 21, generates a document tree 23 (for example, a DOM (Document Object model) tree) which represents a logical structure of the markup document 21 in a tree structure, and loads the document tree into the RAM 107. The document tree 23 is data which has nodes corresponding to respective elements of the markup document 21 and which represents an outline of the markup document 21. The document tree 23 only describes the logical structure of the markup document 21, and does not include information about representation of the document.

The page maker 32 generates an element tree 25 including information of a display style (e.g., block, inline, table, and list) defined by each tag, based on the document tree 23, and executes a registration of a request of an image and an event process designated in the markup document 21 to be stored in the RAM 107. The element tree 25 represents an order in which block, inline, and table, etc., exist. However, the element tree 25 does not include information about which position and with what widths and heights these elements (block, inline, table, etc.) are displayed, and information about from where the text is wrapped, etc.

A page editor 33 determines one-by-one the layout (i.e., wrapping of text, and the position, width and height of each element on the screen) and a color of each node (element) of the element tree 25, and generates a layout tree 27 representing a layout of each element.

Each element for which the layout has been determined is sequentially rendered in the image buffer 1071 generated in a predetermined area of the RAM 107 by the page editor 33. In the image buffer 1071, elements in an area which is to be displayed on the display 111 and elements in a portion surrounding the area are rendered. That is, rendering results (drawing objects) of the whole area of the image buffer 1071 rendered by the page editor 33 are not displayed on one screen. On the display 111, rendering results of an area (hereafter, referred to as “a designated area”) corresponding to a window displaying the Web contents designated by the browser 1051 on the image buffer 1071 are displayed.

The VRAM 115 is a memory storing contents to be directly displayed on the display 111, and has an image area corresponding to the screen size of the display 111. In the VRAM 115, contents rendered, together with an image such as a tool bar, into the designated area of the image buffer 1071 is written. Therefore, when elements for which layouts have been determined are sequentially rendered into the image buffer 1071, rendering results are sequentially written into the VRAM 115. With this configuration, elements of the Web contents are continuously displayed on the display 111. Through the above described process by the browser 1051, the Web contents are displayed on the display 111.

It should be noted that the browser 1051 manages the position of the designated area with respect to the whole Web contents. The browser 1051 moves the designated area in the image buffer 1071 in accordance with a screen scrolling operation. By updating a content written into the VRAM 115 in accordance with movement of the designated area, an area of the Web contents corresponding to the screen scrolling operation is displayed on the display 111.

Incidentally, since the terminal device 10 is a mobile phone, the terminal device 10 is small in size than a PC. Therefore, when the user wants to browse details of the Web contents displayed on the screen the user needs to enlarge the details by operating the browser 1051. Furthermore, there is a problem that the display pixel number of the terminal device 10 is smaller than a PC. Therefore, in a standard magnification (an equivalent magnification), the terminal device 10 is not able to display a considerable amount of the Web contents on one screen. Therefore, when the user wants to browse the whole contents on one screen, the user needs to operate the browser 1051 to reduce the Web contents.

As described above, since the screen size (the display screen size and display pixel number) of the terminal device 10 is small, the user needs to frequently operate the browser 1051 to change the display magnification of the Web contents. Therefore, regarding a device having a small screen size such as the terminal device 10, it is desired to enhance operability to realize an intuitive operation for changing the display magnification. For this reason, the function of changing the display magnification of Web contents through an intuitive user operation (which is described below) is implemented on the browser 1051 according to the embodiment.

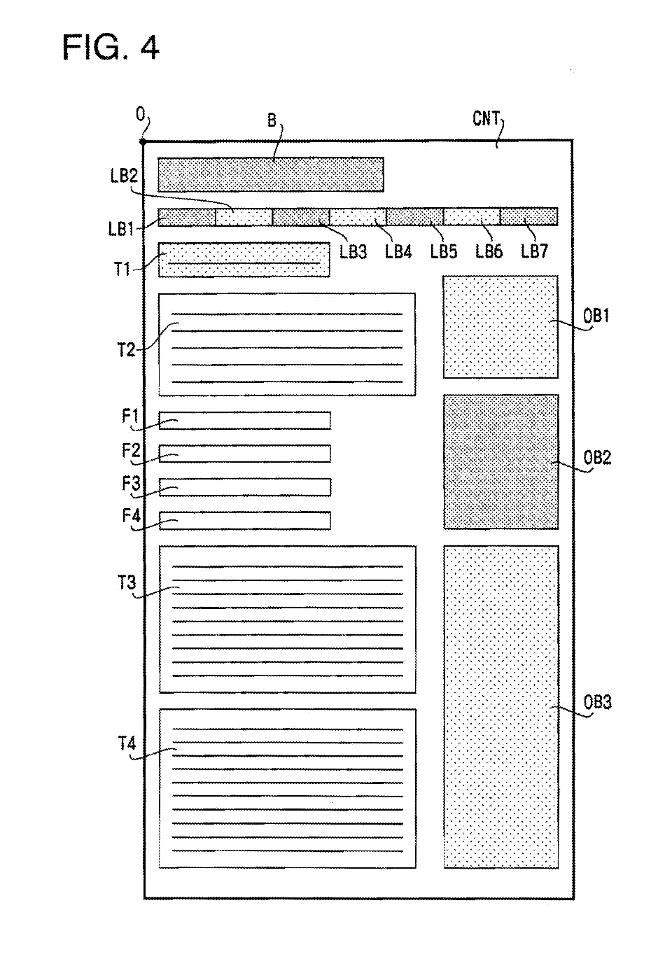

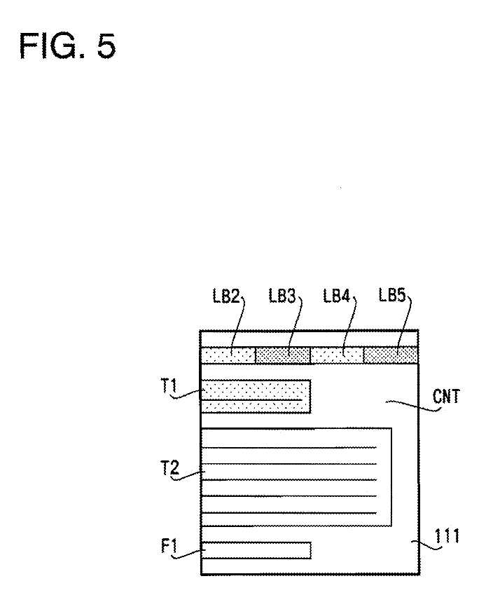

FIG. 4 illustrates the whole Web contents CNT used for the following explanations. In the Web contents CNT, a number of elements including a banner advertisement B, link buttons LB1 to LB7, texts T1 to T7, input forms F1 to F4, and objects OB1 to OB3 are arranged. The Web contents CNT are a Web page created especially for a PC having a standard screen size, e.g., XGA (eXtended Graphics Array), and has the size larger than the screen size of the display 111. Therefore, when the browser 1051 displays the Web contents CNT in the same layout, in which the Web contents CNT are browsed on a PC, and in the standard magnification (equivalent magnification), only a part of the Web contents CNT is displayed on the display 111, for example, as shown in FIG. 5. It should be noted that the Web contents CNT are dynamic contents, and a visual effect is applied to a part of the elements of the Web contents CNT. For example, the banner advertisement B is an animation GIF displaying sequentially a plurality of advertisements in chronological order. The text T1 is described, for example, by a Marquee element, and the text in this element is displayed in a scrolling manner. The text T2 is described, for example, by a blink element, and a part of the text blinks. The object OB1 is an image to which a rollover effect is applied, for example, by Javascript®. The object OB2 is a video object reproduced by a plug-in such as Flash.

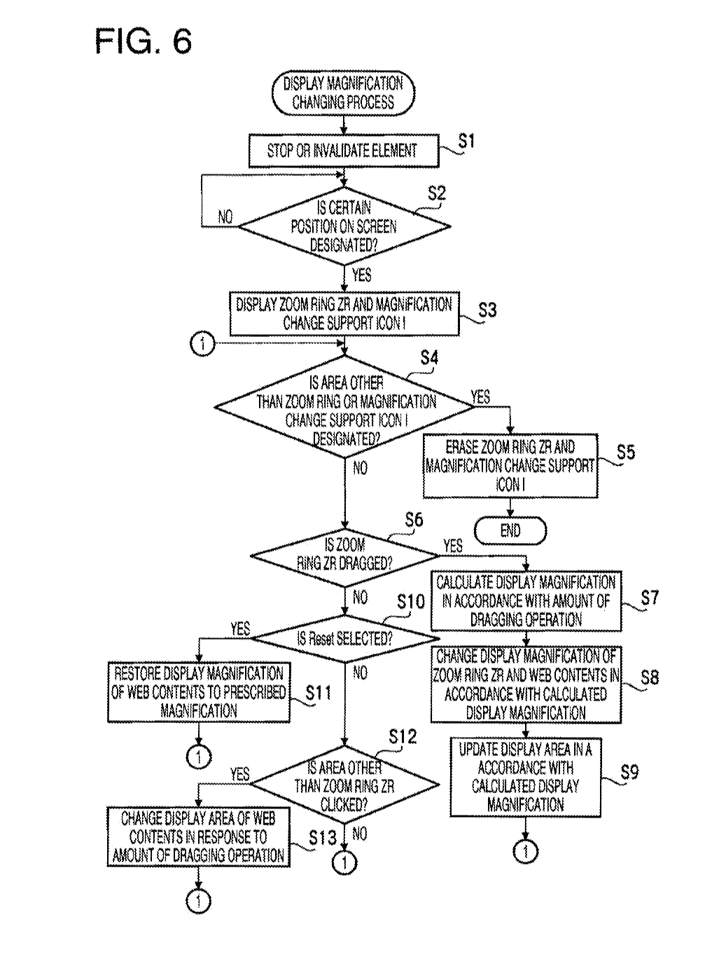

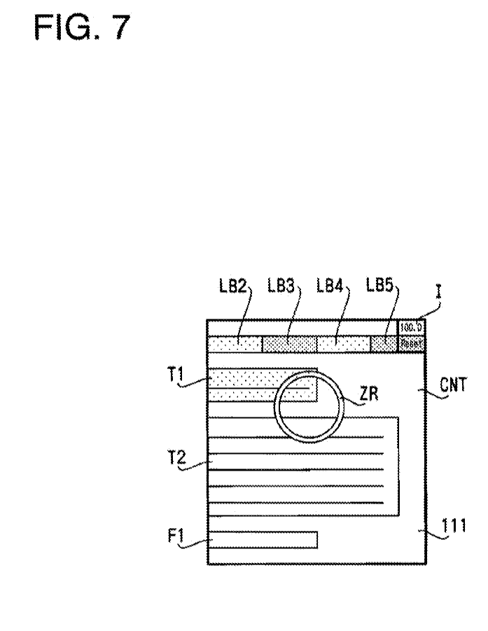

The browser 1051 executes a display magnification changing process suitable for allowing a user to conduct a sensuous user operation for changing the display magnification of the Web contents when the browser 1051 is moved by a user operation to a display magnification change mode for changing the display magnification. In the following, the display magnification changing process is specifically explained with reference to a flowchart of the display magnification changing process shown in FIG. 6 and display examples of the Web contents CNT shown in FIGS. 7 to 9. It should be noted that in the flowchart of FIG. 6 and in the following explanations, each step is abbreviated as “S”.

When the browser 1051 moves to the display magnification change mode, the browser 1051 stops a dynamic element or a function which causes change in a displaying content of the Web contents CNT. Furthermore, the browser 1051 invalidates interaction by a user with respect to a certain element embedded in the Web contents CNT. Specifically, a designating operation with respect to an element, such as a form, an image or an anchor element which can be designated is invalidated (S1).

By the process of S1, the Web contents CNT become a still image in which no element can be designated and which displays contents presented at the point when the operation for moving to the display magnification change mode was conducted. For example, in the banner advertisement B, an advertisement which was displayed at the point when the operation for moving to the display magnification changing operation was conducted is displayed. In the text T1, the text corresponding to the scrolled position determined at the point when the operation for moving to the display magnification change mode was conducted is displayed. In the text T2, an action of the blinking element is stopped and all the text is displayed without blinking as in the case of a normal text. In the object OB1, an image corresponding to a mouse-over event generated at the point when the operation for moving to the display magnification change mode was conducted is displayed. In the object OB2, a frame image presented at the point when the operation for moving to the display magnification change mode was conducted is displayed. Furthermore, all of the elements including the link buttons LB1 to LB7 are brought to the state where the link buttons LB1 to LB7 cannot be designated. It should be noted that the above described elements which cause change of the display content and the elements which are invalidated are cited by way of example. Various types of elements can be employed as the above described elements causing change of the displayed content or being invalidated.

After executing the process of S1, the browser 1051 waits until a certain position on the screen is designated by a user operation (e.g., a click operation or a touch operation) (S2: NO). The user is able to visually recognize the Web contents CNT (a still image) displayed on the screen, and to designate a place which the user wants to enlarge or reduce. Since motions of the dynamic elements which would cause change of the display content have been stopped in the process of S1, the user is able to designate the place which the user wants to enlarge or reduce based on the display content defined at the point when the operation for moving to the display magnification change mode was conducted, i.e., at the point when the user intended to change the display magnification of the Web contents CNT. In another embodiment, dynamic elements may not be stopped. Alternatively, only the function that causes change of the layout (e.g., Javascript® causing change of a layout of each element by processing with respect to a DOM tree) may be stopped.

When the place which the user wants to enlarge or reduce is clicked or touched by the user (S2: YES), the browser 1051 displays a ring-shaped half transparent zoom ring ZR which has a predetermined radius and has the center equal to the clicked or touched position, and displays a magnification change support icon I at the upper right corner of the screen (S3). In the magnification change support icon I, a value (unit: %) of the display magnification of the Web contents is displayed. The value is updated in accordance with the display magnification of the Web contents CNT. It should be noted that the value “100.0” means the Web contents are displayed in the equivalent magnification. The magnification change support icon I has a “Reset” button for restoring the display magnification of Web contents to a prescribed magnification. Whether to display the magnification change support icon I can be set through a user operation.

Since the designating operations with respect to all of the elements are invalidated by the process of S1, the browser 1051 is able to execute the process of S3 without executing the screen transition or displaying a drop-down list even when the link buttons LB1 to LB or the input forms F1 to F4 are designated. It should be noted that the browser 1051 manages positions of elements, pointers, designated areas and etc. in the whole Web contents CNT based on a coordinate system having the origin point equal to at the upper left corner of the Web contents CNT (a point O in FIG. 4).

In another embodiment, the browser 1051 may execute processes from S2 without executing the process of S1. In this case, the browser 1051 executes the processes from S3 only when an element other than the elements which can be designated is clicked or touched, and executes a normal process such as a screen transition to a linked destination when an element which can be designated, such as an anchor element, is designated. Alternatively, the browser 1051 may move to the display magnification change mode only when an element other than the elements which can be designated is clicked or touched, and then execute the processes after S3. In the latter case, to prevent occurrence of unintended transition to the display magnification change mode, the browser 1051 may move to the display magnification change mode only when an element other than the elements which can be designated is double-clicked, double-tapped or pushed for a long time.

After the browser 1051 executes the process of S3 and displays the zoom-ring ZR and the magnification change support icon I, the browser 1051 monitors user operations. The user operations to be monitored by the browser 1051 are the following operations (1) to (4).
(1) A click operation or a touch operation with respect to an area on the Web contents CNT other than the zoom ring ZR and the magnification change support icon I (S4)
(2) A dragging operation with respect to the zoom ring ZR (S6)
(3) A click operation or a touch operation with respect to the “Reset” button of the magnification change support icon I (S10)
(4) A dragging operation with respect to an area on the Web contents CNT other than the zoom ring ZR (S12)
   It should be noted that the dragging operation includes an operation of pressing an operation key for designating a dragging target when a pointer is placed on the dragging target and then moving the pointer in a state where the operation key is pressed, and an operation of touching a dragging target on the screen and sliding the touched point on the screen in a state where the dragging target is touched.

When an area on the Web contents CNT other than the zoom ring ZR and the magnification change support icon I is clicked or touched (S4: YES), the browser 1051 erases the zoom ring ZR and the magnification change support icon I (S5), terminates the display magnification changing process, and returns from the display magnification change mode to the previous mode designated before moving to the display magnification change mode.

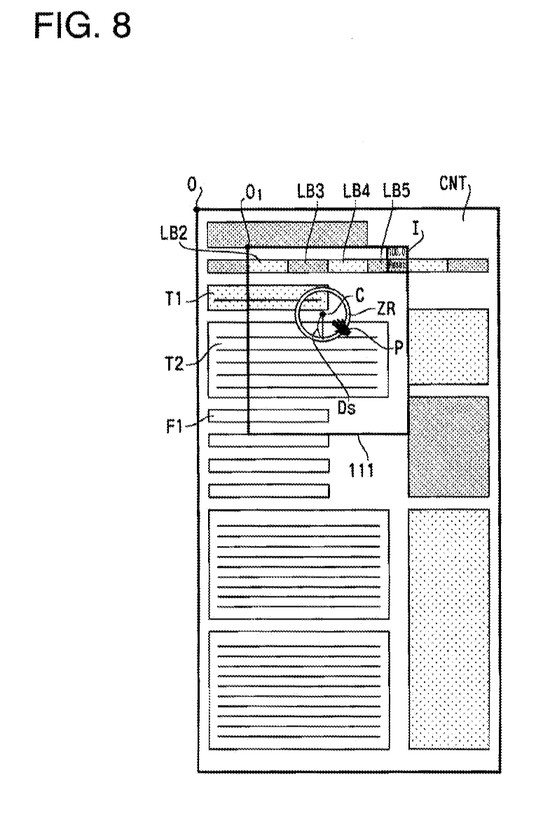

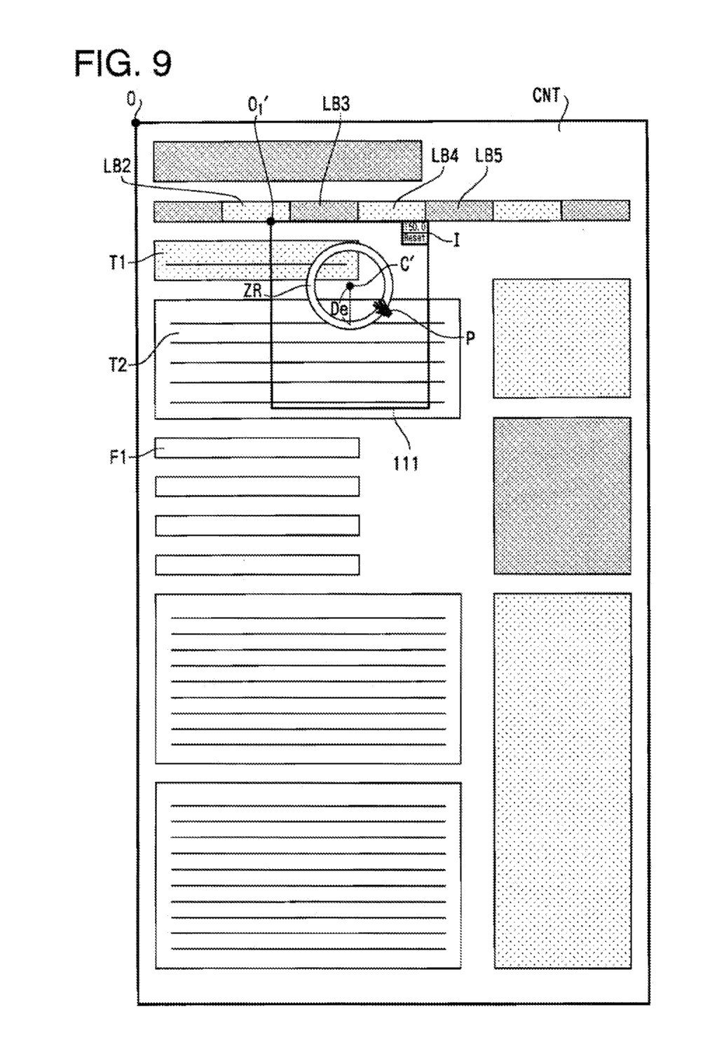

When the dragging operation is conducted with respect to the zoom ring ZR (S4: NO, S6: YES), the browser 1051 repetitively executes the processes of S7 to S9 at a predetermined interval until the dragging operation is stopped. FIGS. 8 and 9 are explanatory illustrations for explaining the processes of S7 to S9. FIG. 8 illustrates a relationship defined, between the whole Web contents CNT and an area displayed on the screen, before the dragging operation with respect to the zoom ring ZR is conducted. FIG. 9 illustrates a relationship defined, between the whole Web contents CNT and the area displayed on the screen, after the dragging operation with respect to the zoom ring ZR is conducted. As shown in FIG. 8, the zoom ring ZR before the dragging operation has the radius of Ds, and is displayed to have the center equal to the coordinate C. The radius of the zoom ring ZR is defined as an average of the inner radius and the outer radius of the ring.

Let us consider a case where the user operates the pointer P and drags the zoom ring ZR to move the zoom ring ZR toward the direction deviating from the coordinate C or the direction approaching the coordinate C by a distance ΔD (a distance is defined by the pixel number). When Mp represents the display magnification of the Web contents CNT immediately before the dragging operation, Ds represents a distance between the coordinate C and the pointer P (the center of a pointer image) immediately before the dragging operation (Ds is substantially equal to the radius of the zoom ring ZR before the dragging operation), and De (=Ds+ΔD) represents a distance between the coordinate C and the pointer P (the center of the pointer image) immediately after the dragging operation, the browser 1051 calculates the display magnification Mn for the Web contents immediately after the dragging operation by using the following equation (S7).

Mn=Mp·De/Ds

The browser 1051 changes the display size of the zoom ring ZR in accordance with the calculated display magnification Mn, and applies the change of the display size of the zoom ring ZR to the Web contents (S8). That is, the browser 1051 enlarges or reduces the Web contents with the same scaling factor as the scaling factor of the zoom ring ZR. The browser 1051 updates the radius of the zoom ring ZR from the radius Ds to the radius De. Therefore, the user is able to sensuously grasp what magnification the Web contents CNT are displayed at, by conducting the dragging operation with respect to the zoom ring ZR to change the display size and by visually recognizing the degree of change.

When the display magnification is changed, the Web contents CNT are enlarged or reduced in all directions uniformly. Similarly, the ring of the zoom ring ZR is enlarged or reduced in all direction uniformly with respect to the center (the coordinate C) in accordance with the dragging operation. As described above, both of the Web contents CNT and the zoom ring ZR change their display sizes in all directions uniformly. Therefore, by visually checking the change of the display size of the zoom ring ZR, the user is able to visually recognize the change of the display magnification of the Web contents CNT easily.

By setting the shape of a UI (User Interface) for changing the display magnification to be a ring-like shape such as the zoom ring ZR, the UI itself does not block display of the Web contents arranged inside the ring (i.e., display of the place which the user has clicked or touched to enlarge or reduce). Furthermore, since the ring is half transparent, the ring does not completely block display of the Web contents.

With regard to the conventional display magnification changing operation such as a pinching operation described in the patent document 1, there is a problem that the place to be focused is blocked, for example, by a user's finger and cannot be visually recognized. By contrast, by changing the display magnification using the browser 1051, occurrence of such a problem is prevented. That is, according to the browser 1051, since the display magnification is changed by placing the user's finger, the pointer and etc. on the ring to change the display magnification, a place which the user wants to watch carefully, i.e., an area close to the center of the zoom ring ZR, is not blocked by the pointer, the user's finger and etc, the user's attention is not blocked.

It should be noted that the width of the ring of the zoom ring ZR is set appropriately to the extent that the display of the Web contents are not blocked as much as possible and the user is able to easily drag the ring.

With regard to the conventional display magnification changing operation where a user changes the display magnification by selecting options on a tool bar or operating a zoom bar, there is a case where a place which the user wants to carefully watch deviates from the display screen while the user enlarges the Web contents. To prevent occurrence of such a problem, the browser 1051 executes the process of S9 concurrently with the process of S8, i.e., the browser 1051 changes the display size of the zoom ring ZR and the display magnification of the Web contents CNT, and concurrently determines the display area of the Web contents CNT so that the place which the user wants to watch carefully (i.e., the center of the zoom ring ZR) is constantly displayed at the same position on the display screen.

Specifically, the browser 1051 updates the coordinates on the Web contents CNT based on the changed display magnification, and then calculates again the coordinate at which the center of the zoom ring ZR is located on the Web contents CNT after change of the display magnification. Through such re-calculation, the coordinate at which the center of the zoom ring ZR is located on the Web contents is changed from the coordinate C to the coordinate C′. Next, the browser 1051 sets the designated area on the image buffer 1071 so that the position of the coordinate C′ on the display screen obtained by the re-calculation coincides with the coordinate C on the display screen before change of the display magnification. In order to set the designated area, the browser 1051 determines the coordinate O′ so that the relative position between the coordinate C′ and the coordinate O₁′ of the upper left corner of the designated area after change of the display magnification is equal to the relative position between the coordinate C and the coordinate O₁ of the upper left corner of the designated area before change of the display magnification. Then, the browser 1051 sets, as the designated area, a rectangular area having the height and width corresponding to the display screen size.

As a result, as shown in FIG. 9, the zoom ring ZR is displayed on the display screen in an enlarged state at the position having the center equal to the coordinate C′, and, on the backside of the zoom ring ZR, the Web contents CNT are displayed in the same scaling factor as that of the zoom ring ZR. As shown in FIG. 9, even when the display magnification of the Web contents CNT is changed, the place which the user wants to carefully watch is displayed at the same position on the display screen as that defined before change of the display magnification, and therefore the place does not deviate from the display screen.

As described above, the coordinate system managed by the browser 1051 is a coordinate system (hereafter, referred to as “a content coordinate system”) having the origin point (0, 0) corresponding to the coordinate O. In addition to the content coordinate system, the browser 1051 manages a coordinate system (hereafter, referred to as “a display screen coordinate system”) having the origin point corresponding to the coordinate of the upper left corner of the display screen (the coordinate O₁ in FIG. 8 or the coordinate O₁′ in FIG. 9). In each of the content coordinate system and the display screen coordinate system shown, for example, in FIGS. 8 and 9, the rightward direction from the origin point is defines as the X-axis direction, and the downward direction from the origin point is defined as the Y-axis direction.

Let us consider the case where a coordinate P(X,Y) is designated when the display magnification of the Web contents CNT is M0, and the display magnification of the Web contents CNTY is changed to M1 . In this case, we define a coordinate of the origin point of the display screen coordinate system in the content coordinate system as (Vx0, Vy0). The coordinate P in the content coordinate system defined when the display magnification of the Web contents CNT is equal to the equivalent magnification (=1.0) is represented by ((Vx0+X)/M0, (Vy0+Y)/M0). We define that a coordinate of the origin point of the display screen coordinate system in the content coordinate system defined when the display magnification of the Web contents CNT is changed to M1 is (Vx1, Vy1). In this case, regarding the coordinate P′ which is (X,Y) in the display screen coordinate system, the coordinate P′ in the content coordinate system is represented by ((Vx1+X)/M1, (Vy1+Y)/M1). The browser 1051 calculates the coordinate (Vx1, Vy1) satisfying the following equation so that the coordinate P and the coordinate P′ have the same coordinate (X,Y) in the display screen coordinate system, and sets the calculated coordinate (Vx1, Vy1) as the origin point of the display screen coordinate system.

((Vx0+X)/M0, (Vy0+Y)/M0)=((Vx1+X)/M1, (Vy1+Y)/M1)

Through such calculation, the center position of the zoom ring ZR is kept at the coordinate (X, Y) in the display screen coordinate system, i.e., the same position in the display screen, regardless of the display magnification.

Since the display magnification of the Web contents CNT changes continuously, it is preferable that the above described re-calculation of the origin point of the display screen coordinate system is performed at a high speed. In order to secure the effectiveness of the high speed calculation, the browser 1051 calculates initially the coordinate value of the coordinate P in the content coordinate system defined when M0=1.0 and stores the coordinate value. Then, each time the changed display magnification M1 is determined, the browser 1051 calculates the coordinate (Vx1, Vy1) by a simple calculation based on the above described stored coordinate value and the change rate (=M1/M0) of the display magnification. In this case, since the amount of calculation for obtaining the coordinate (Vx1, Vy1) can be reduced, increase of the calculation speed can be achieved.

The ring is a group of dots arranged to have the same distance from the center coordinate of the ring. As described above, the center coordinate is fixed at the same position on the display screen. The zoom ring ZR can be realized by adjusting the radius of the ring with respect to the center coordinate. That is, the degree of change of the display magnification of the Web contents CNT is determined only from the amount of dragging operation with respect to the fixed center coordinate (i.e., the physical amount of sliding of the user's finger on the screen). At any position of the zoom ring ZR (e.g., the center of the screen or an edge of the screen), the user is able to constantly obtain the same result (a result of display of the Web contents CNT for which the display magnification has been changed) by the same operation, without the need for considering the direction of the display screen (the aspect ratio of the display screen) and the direction of the dragging operation. Therefore, the user does not have uncomfortable feeling in regard to the input manner or sense of operation (prediction of a result with respect to the input) regardless of the position of the zoom ring ZR on the display screen.

There is a case where, when the Web contents CNT are reduced excessively, the zoom ring ZR is displayed in an extremely reduced size, it becomes difficult to put a pointer or a user's finger on the zoom ring ZR. In order to solve such a problem, when the “Reset” button of the magnification change support icon I is clicked or touched (S4: NO, S6: NO, S10: YES), the browser 1051 restores the display magnification of the Web contents CNT to the prescribed magnification (S11), and returns to the state of monitoring the above described operations (1) to (4). The prescribed magnification is, for example, the equivalent magnification. By restoring displaying of the zoom ring ZR to displaying in the equivalent magnification together with the Web contents CNT, it becomes possible to restore to the state where the user is able to easily drag the zoom ring ZR.

The display magnification defined when the “Reset” button is selected may be set by a user operation. Depending on a user setting, the browser 1051 may operate such that, in addition to the display magnification of the Web contents, the display layout of the Web contents is restored to a prescribed layout (e.g., the same layout as that used to browse contents on a PC) when the “Reset” button is selected.

When an area on the Web contents CNT other than the zoom ring ZR is dragged (S4: NO, S6: NO, S10: NO, S12: YES), the browser 1051 scrolls or slides the display area of the Web contents CNT in response to the dragging operation in a state where the display position of the zoom ring ZR on the screen is fixed (S13). As a result, the browser 1051 is able to substantially move the zoom ring ZR in respect to the Web contents CNT so that the place which the user wants to carefully watch, i.e., the area close to the center of the zoom ring ZR, can be changed appropriately. Depending on a user setting, when the area on the Web contents CNT other than the zoom ring ZR is dragged, the browser 1051 may move the zoom ring ZR together with the display area of the Web contents CNT in response to the dragging operation in a state where the relative position between the zoon ring ZR and the Web contents CNT is fixed. The scrolling process or the sliding process in S12 or S13 is not limited to being processed in response to the dragging operation, but may be processed in response to a key operation by the five-way key 113a or the ten-key 113b. Alternatively, the scrolling process or the sliding process may be executed based on the measured value from various types of sensors. When the terminal device 10 has another type of operation key such as a jog dial, the scrolling process or the sliding process may be executed in response to an operation to such an operation key.

The present invention is not limited to the above described embodiment, but may be varied within the scope of the technical concept of the present invention. For example, the content display magnification changing method and the content display magnification changing program according to the invention may be applied to another type of image viewer such as a

PDF (Portable Document Format) viewer.

As a UI for changing the display magnification, a marker or a character formed such that a user is able to recognize the center thereof or a marker or a character selected by a user setting may be employed in place of the zoom ring ZR. As an example of such a UI, a regular triangle having three lines can be cited. With regard to a regular triangle, display of an area which is surrounded by the lines and which a user wants to carefully watch is not blocked by the UI itself. In this case, the user conducts a dragging operation by clicking or touching one of the three lines. When the regular triangle UI is dragged, the regular triangle UI is broadened or narrowed uniformly in all the directions with respect to the center position thereof. Therefore, the user is able to visually recognize change of the display magnification of the Web contents easily, by following the change of the display size of the regular triangle UI.

The UI for changing the display magnification is not limited to a still image, but may be a UI in which a display content is dynamically changed, for example, by an animation process. For example, with regard to the regular triangle UI, a visual effect in which a triangle rotates about the center thereof may be applied to the UI.

The UI for changing the display magnification is not limited to a simple shape such as a ring or a regular triangle, but may be a complicated shape as long as the UI is formed such that a user is able to visually recognize the state where the UI is broadened or narrowed uniformly with respect to the center position during the dragging operation. For example, the UI may have a complicated shape such as a flower opened up on a pot. In this case, various types of visual effects, such as an effect where petals are rotating or leaves are waving can be applied to the UI.

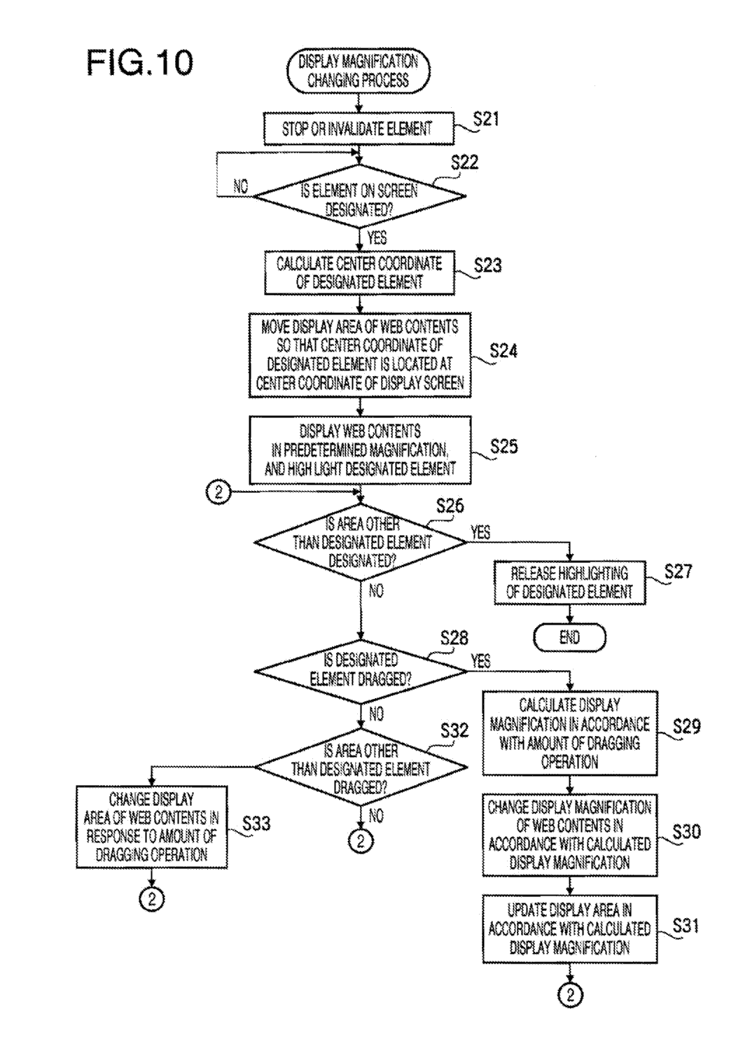

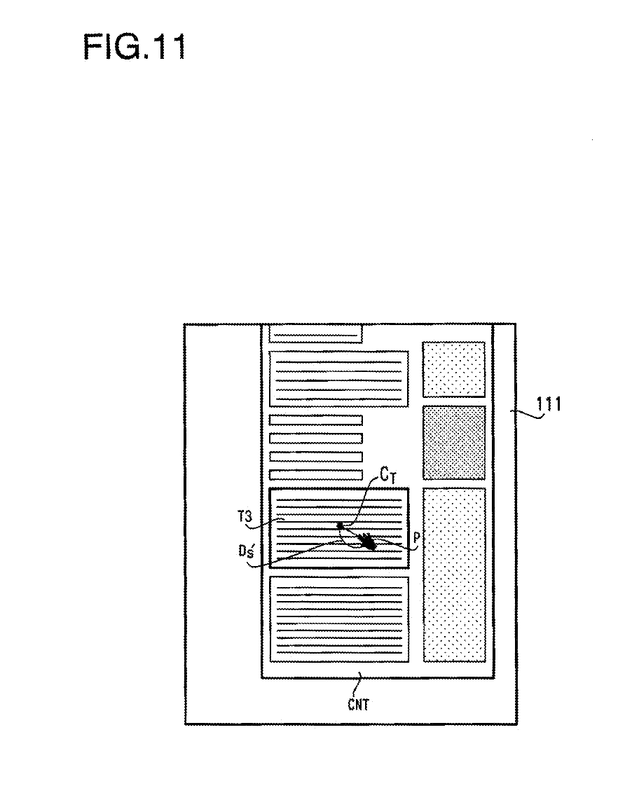

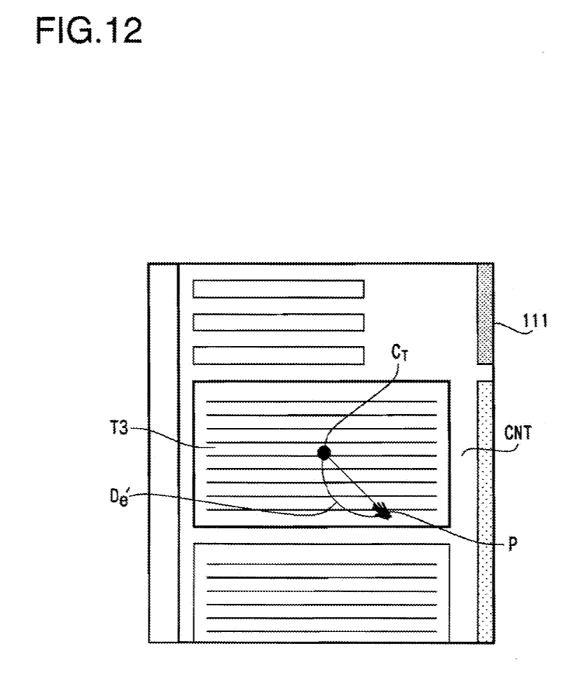

An embodiment in which the display magnification of the Web contents can be changed through a sensuous operation without using any UI for changing the display magnification can be considered. FIG. 10 is a flowchart illustrating a display magnification changing process executed by the browser 1051 according to such an embodiment. FIGS. 11 and 12 show examples of display of the Web contents CNT according to such an embodiment.

When the browser 1051 moves to the display magnification change mode, the browser 1051 executes a process (stopping or invalidation of elements) similarly to the process of S1 in FIG. 6 (S21). Then, the browser 1051 waits until a user operation for designating an element on the screen is conducted (S22: NO). When an element on the screen is clicked or touched (S22: YES), the browser 1051 calculates the center coordinate of the touched or clicked element (S23). Let us consider the case where the text T3 is touched. The browser 1051 calculates the center coordinate C_{T} of the text T3 based on the display height, display width and the display position of the text T3.

The browser 1051 moves the display area of the Web contents CNT so that the center coordinate C_{T} of the text T3 is located at the center coordinate of the display screen (S24), and then sets the display magnification of the Web contents CNT to a predetermined magnification. Furthermore, the browser 1051 highlights the text T3 (for example, by surrounding the text T3 by a bold frame) (S25). The predetermined magnification means a magnification adapted to display the entire designated element and surrounding elements on one screen. For example, the predetermined magnification is determined based on the display height and display width of the designated element. FIG. 11 illustrates an example of display of the Web contents CNT immediately after execution of the process of S25.

After the process S25 is executed, the browser 1051 monitors the operations by a user. The user operations to be monitored by the browser 1051 are the following operations (5) to (7).
(5) A click operation or a touch operation with respect to an area on the Web contents CNT other than the element designated in the process of S22 (S26).
(6) A dragging operation with respect to the element designated in the process of S22 (S28).
(7) A dragging operation with respect to an area on the Web contents CNT other than the element designated in the process of S22 (S32).

When an element other than the element designated in the process of S22, i.e., the area on the Web contents CNT other than the text T3, is clicked or touched (S26: YES), the browser 1051 releases the state of highlighting the text T3 (S27) to terminate the display magnification changing process, and returns from the display magnification change mode to the previous mode defined before the display magnification change mode.

When the element designated in the process of S22, i.e., the text T3, is dragged (S26: NO, S28: YES), the browser 1051 repetitively executes at a predetermined period the processes S29 to S31 similar to the processes of S7 to S9 in FIG. 6 until the dragging operation is stopped. Specifically, when Mp represents the display magnification of the Web contents immediately before the dragging operation, Ds' represents the distance between the center coordinate C_{T} and the pointer P (the center of the pointer image) defined immediately before the dragging operation, De′ represents the distance between the center coordinate C_{T} and the pointer P (the center of the pointer image) immediately after the dragging operation, the browser 1051 calculates the display magnification Mn of the Web contents immediately after the dragging operation by using an equation indicated below (S29).

Mn=Mp·De′/Ds′

Next, the browser 1051 fixes the display position of the text T3 at the center of the display screen, and concurrently changes the display magnification of the whole Web contents including the text T3 in accordance with the calculated display magnification Mn (S30, S31). In other words, the browser 1051 enlarges or reduces the text T3 displayed at the screen center and elements surrounding the text T3 in accordance with the amount of dragging operation of the pointer P with respect to the center coordinate C_{T} (i.e., how long the pointer P is moved to the center coordinate C_{T} or moved away from the center coordinate C_{T}). When the pointer P is dragged so that the pointer P moves away by ΔD′ (=De′−Ds′) from the center coordinate C_{T}, the Web contents CNT are displayed on the display screen to have the center equal to the position of the text T3 as shown in FIG. 12.

When an element other than the element designated in the process of S22, i.e., the area on the Web contents CNT other than the text T3 is dragged (S26: NO, S28: NO, S32: YES), the browser 1051 scrolls or slides the display area of the whole Web contents CNT including the text T3 in response to the dragging operation (S33).

In this embodiment, the browser 1051 may display the magnification change support icon I so that the processes of S10 and S11 of FIG. 6 can be executed.

As described above, in this embodiment, the whole Web contents including an element which the user wants to carefully watch (the text T3) can be enlarged or reduced with respect to the element in accordance with the amount of dragging operation. The user is able to sensuously recognize what magnification the Web contents CNT is displayed at, by visually recognizing the amount of dragging operation with respect to the element which the user wants to carefully watch and the degree of change of the display size of the element in response to the dragging operation.

1. A content display magnification changing method executed in a state where contents are displayed on a display screen, comprising:
an indicator setting step of setting a predetermined indicator;
an indicator size changing step of changing a display size of the indicator in response to an amount of dragging operation when a dragging operation with respect to the set indicator is accepted; and
a content display magnification changing step of changing a display magnification of the contents in accordance with change of the display size of the indicator.

2. The content display magnification changing method according to claim 1,
wherein, in the content display magnification changing step, the display magnification is changed by applying a change rate of the display size of the indicator to the display magnification of the contents such that a rate between the display size of the indicator and a display size of the contents is kept constant.

3. The content display magnification changing method according to claim 1,
wherein, in the content display magnification changing step, the display magnification of the contents is changed in a state where a center of a display position of the indicator on the display screen is fixed.

4. The content display magnification changing method according to claim 1, wherein, in the indicator setting step, a predetermined indicator image is displayed at a position on the display screen designated by a user operation.

5. The content display magnification changing method according to claim 4,
wherein the predetermined indicator image is a ring-shaped mark having a center equal to a position of the display screen designated by the user operation.

6. The content display magnification changing method according to claim 5,
wherein, in the indicator size changing step, when a dragging operation is conducted with respect to the ring-shaped mark, a display size of the ring-shaped mark is changed in response to an amount of the dragging operation.

7. The content display magnification changing method according to claim 6,
wherein, in the indicator size changing step, the amount of the dragging operation is determined based on a difference between a distance between the center of the ring-shaped mark and a designation start point of the user operation and a distance between the center of the ring-shaped mark and a designation end point of the user operation.

8. The content display magnification changing method according to claim 7,
wherein, in the indicator size changing step,
when the designation end point is moved from the designation start point of the user operation to approach the center of the ring-shaped mark, the indicator is reduced and displayed in accordance with the difference, and
when the designation end point is moved from the designation start point to be away from the center of the ring-shaped mark, the indicator is enlarged and displayed in accordance with the difference.

9. The content display magnification changing method according to claim 5,
further comprising a ring-shaped mark erasing step of erasing the ring-shaped mark when an area on the contents other than the ring-shaped mark is designated.

10. The content display magnification changing method according to claim 1,
wherein, in the indicator setting step, an element of the contents designated by a user operation is set as the predetermined indicator.

11. The content display magnification changing method according to claim 10, wherein, in the indicator setting step, the element designated as the indicator is highlighted.

12. The content display magnification changing method according to claim 10,
wherein, in the indicator setting step, the element designated as the indicator is displayed at a center of the display screen.

13. The content display magnification changing method according to claim 1, further comprising a dynamic element stopping step of stopping or invalidating a dynamic element of elements of the contents.

14. The content display magnification changing method according to claim 1, further comprising:
an icon display step of displaying a predetermined icon supporting change of the display magnification of the contents; and
a prescribed magnification setting step of setting the display magnification of the contents to a prescribed magnification when the icon is designated.

15. The content display magnification changing method according to claim 1, further comprising:
a content display area change step of, when a dragging operation is conducted with respect to an area on the contents other than the indicator, scrolling or sliding a display area of the contents in response to the dragging operation in a state where a display position of the indicator is fixed.

16. (canceled)

17. A computer readable medium having computer readable instruction stored thereon, which, when executed by a processor of a computer, configures the processor to perform, in a state where contents are displayed on a display screen, the steps of:
an indicator setting step of setting a predetermined indicator;
an indicator size changing step of changing a display size of the indicator in response to an amount of dragging operation when a dragging operation with respect to the set indicator is accepted; and
a content display magnification changing step of changing a display magnification of the contents in accordance with change of the display size of the indicator.

18. A terminal device, comprising:
an indicator setting unit configured to set a predetermined indicator;
an indicator size changing unit configured to change a display size of the indicator in response to an amount of dragging operation when a dragging operation with respect to the set indicator is accepted; and
a content display magnification changing unit configured to change a display magnification of the contents in accordance with change of the display size of the indicator.
